(19) United States
(12) Patent Application Publication
(10) Pub. No.: US 2025/0199473 A1
(43) Pub. Date: Jun. 19, 2025

(54) POSITION-SETTING AND MARKING DEVICE FOR A TIMEPIECE MECHANISM

(71) Applicant: Montres Breguet S.A., L'Abbaye (CH)

(72) Inventor: Grégory GAUTHIER, Saint-Cergue (CH)

(73) Assignee: Montres Breguet S.A., L'Abbaye (CH)

(21) Appl. No.: 18/917,055

(22) Filed: Oct. 16, 2024

(30) Foreign Application Priority Data
Dec. 19, 2023 (EP) 23217979.6

(51) Int. Cl. G04B 15/12; G04D 3/00

(52) U.S. Cl. CPC G04B 15/12; G04D 3/0079

(57) ABSTRACT

A device (100) for setting the position and marking a first (1) and a second (10) timepiece component, which can be assembled together with a single degree of freedom and immobilised by the cooperation of a first screw (4) with a first tapping (12) of the second component (10) via a first notch (2) of the first component (1), and of a second screw (5) with a second tapping (13) of the second component (10) via a second notch (3) of the first component (1), the first (2) and second (3) notches defining a setting range, the second screw (5) being a cone-head screw, arranged to make an imprint on the edge of the second notch (3) under a predetermined tightening torque, in order to permanently mark the relative position of the first component (1) and of the second component (10).

### CROSS REFERENCE TO RELATED APPLICATION

This application claims priority to European Patent Application No. 23217979.6 filed Dec. 19, 2023, the entire contents of which are incorporated herein by reference.

### TECHNICAL FIELD OF THE INVENTION

The invention relates to a position-setting and marking device for setting the position of and immobilising a first component and a second component of a timepiece mechanism relative to one another, the said first component and the said second component being arranged so as to be assembled with each other with a single degree of freedom in rotation or translation, and so as to be immobilised with each other by the cooperation of a first screw with a first tapping that the said second component has through a first notch that the said first component has.

The invention also relates to a timepiece mechanism including at least one such position-setting and marking device.

The invention also relates to a timepiece including at least one such position-setting and marking device, and/or one such timepiece mechanism.

The invention relates to the field of setting mechanisms for timepiece mechanisms.

### Technological Background

Fixing timepiece components is a delicate operation, because clamping in position may disturb an already difficult setting.

It is usual to manually set the relative position of the components of a timepiece sub-assembly in the optimum operating position, then to lock the setting position obtained in this way, by one or more flat-head screws, known as “bearing screws”, held in abutment by the lower flat annular surface of their head on a flat surface of a component. For example, it is common practice to set a component using an eccentric and then lock it using a screw.

In particular, the positioning of rollers or various horological components, such as snails, cams, moon discs or other calendar or striking elements, or others, requires a high degree of indexing precision, independently of manufacturing clearances and assembly clearances.

However, when two components are indexed relative to each other, the use of flat head screws means that the indexing cannot be reproduced during successive dismantling/reassembly operations. The horologist is therefore obliged to locate the indexing position with each assembly, as during the initial assembly.

### SUMMARY OF THE INVENTION

The purpose of the invention is to provide means for effectively holding two components in position relative to each another and, after subsequent dismantling, for allowing reassembly in the last setting position to facilitate the task of the horologist, particularly the horologist repairer.

The invention uses a screw with a non-flat head, capable of imprinting a mark on one of the components, constituting a mark in the setting position.

In particular, the use of a conical head makes it easy to mark the edge of a bed during initial assembly, without creating chips, and then to relocate the indexing position during subsequent reassemblies.

To this end, the invention relates to a position-setting and marking device for setting in position and immobilising a first component and a second component in relation to each other, which includes a timepiece mechanism, the said first component and the said second component being arranged so as to be assembled with each other with a single degree of freedom in rotation and/or translation, and so as to be immobilised with each other by the cooperation of a first screw with a first tapping that the said second component has through a first notch that the said first component has. A single degree of freedom in rotation and translation is defined by a mechanical connection of the helical type.

According to the invention, said first component and said second component are further arranged to be immobilised relative to one another by the cooperation of a second screw with a second tapping that said second component has, through a second notch that said first component has, said first notch and said second notch defining a setting range according to said single degree of freedom. And the said first screw is a bearing screw, which is arranged, when subjected to a first tightening torque, to create friction allowing a setting of the relative positioning between the said first component and the said second component according to the said single degree of freedom, and, when subjected to a second tightening torque greater than the said first tightening torque, to immobilise the said first component and the said second component in position relative to each other. And the said second screw is a screw with a non-flat head, capable of imprinting a mark on the edge of the said second notch when it is subjected to a third predetermined tightening torque, to permanently mark the position imposed on the said first component and the said second component relative to each other, and to relocate it after dismantling and during subsequent reassembly.

The invention also relates to a timepiece including at least one such position-setting and marking device, and/or one such a timepiece mechanism.

The invention relates to the field of setting mechanisms for timepiece mechanisms.

### BRIEF DESCRIPTION OF THE FIGURES

The aims, advantages and features of the invention will become clearer from the detailed description that follows, with reference to the attached drawings, in which:

FIG. 1 illustrates, in schematic form and in cross-section passing through an axis of rotation, a non-limiting example of the application of the invention in which a first component, consisting of a cylindrical tube including a flange, is mounted so as to pivot about a second component consisting of a shaft, and needs to be precisely aligned. The position-setting and marking device according to the invention enables the position of this first and this second component to be set and immobilised relative to each other. The first component has two grooves, a first groove at the top of the figure and a second groove at the bottom of the figure respectively. The second component has two tappings, a first tapping at the top of the figure and a second tapping at the bottom of the figure respectively. A first bearing screw bears on a flat surface of the first component, passes through the first groove and is screwed into the first tappings. A second screw with a non-flat head, in particular a conical head, bears on another surface of the first component, passes through the second groove and is screwed into the second tapping and, when this screwing is carried out, is arranged, under the action of a predetermined tightening torque, to imprint an impression on the edges of the second groove;

FIG. 2 shows a schematic side view of the first component and second component of FIG. 1, and shows the first bearing screw and the second screw with a non-flat head engaged in their respective grooves and bearing on a face of the first component;

FIG. 3 is a block diagram representing a timepiece, in particular a watch, including a timepiece mechanism itself incorporating a position-setting and marking device according to the invention.

### DETAILED DESCRIPTION OF THE INVENTION

The invention relates to a position-setting and marking device (100) for setting the position of two components of a timepiece mechanism (500) and immobilising them relative to each other.

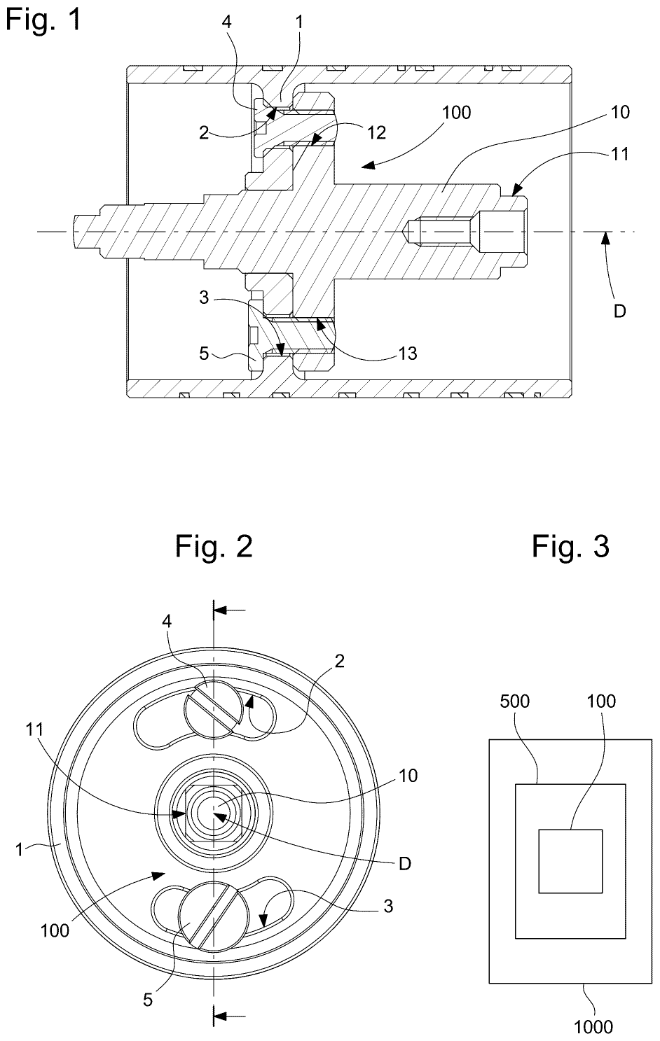

In particular, in the embodiment of the invention shown in FIGS. 1 and 2, a first component 1 is formed by a cylindrical tube including a flange, and is mounted so as to be able to rotate about a second component 10 formed by a shaft. The first component and the second component need to be precisely aligned with each other. To this end, the second component 10 includes, for example, a flat surface 11 forming a maneuvering surface, as shown in FIG. 2.

The first component 1 and the second component 10 are arranged to be assembled with each other with a single degree of freedom in rotation and/or in translation, and to be immobilised with each other at least by the cooperation of a first screw 4 with a first tapping 12 of the second component 10. The first tapping 12 is intended to be aligned with a first notch 2 in the first component 1, through which the first screw 4 is engaged.

According to the invention, the first component 1 and the second component 10 are further arranged to be immobilised with each other by the cooperation of a second screw 5 with a second tapping 13 of the second component 10. The second component 10 is intended to be aligned with a second notch 3 in the first component 1, through which the second screw 5 is engaged.

The first notch 2 and the second notch 3 define a setting range according to this single degree of freedom.

The first screw 4 is a flat-head screw, for example, a bearing screw arranged, when subjected to a first tightening torque, to create friction allowing a setting, for example a fine setting, of the relative positioning between the first component 1 and the second component 10 according to the single degree of freedom. When subjected to a second tightening torque greater than the first tightening torque, the first screw 4 enables the first component 1 and the second component 10 to be immobilised in position relative to each other.

The second screw 5 is a screw with a non-flat head, for example a screw with a conical head, designed to deform the material of the first component 1 to make an imprint on the edge of the second notch 3 when it is subjected to a third tightening torque. This imprint makes it possible to permanently mark the position imposed on the first component 1 with respect to the second component 10, so that this imposed position can be located again after disassembly, during subsequent reassembly.

In the example shown in FIG. 1, during a first assembly, the first screw 4 is tightened so that its head bears against a face of the first component 1 by a tightening to the first torque in order to generate friction allowing relative movement between the first component and the second component 1 and 10. The first component and the second component 1 and 10 are then moved relative to each other to achieve a desired indexing position. Once the desired relative position has been reached, the second screw 5 is tightened to mark the edge of the second oblong 3. The first screw 4 is then tightened to the second torque to lock the relative position. During subsequent reassembly, the imprint generated by the head of the second screw 5 makes it easy to relocate the initial setting position.

It should be noted that the second tightening torque is preferably greater than the third tightening torque. In this way, the first component 1 is not excessively marked. The service life is ensured by tightening the first screw 4 to the second tightening torque.

In the embodiment shown in FIG. 2, the first component 1 and the second component 10 are arranged to be assembled together with a single degree of freedom in rotation about an axis of rotation, the first notch 2 and the second notch 3 being formed by oblong grooves that are concentric with respect to said axis of rotation.

In another embodiment of the invention, the first component 1 and the second component 10 are arranged to be assembled with each other with a single degree of freedom in translation, the first notch 2 and the second notch 3 being formed by aligned or parallel straight grooves.

In yet another embodiment of the invention, the first component 1 and the second component 10 are arranged to be assembled with each other in a helical connection, i.e. with a single degree of freedom in translation and rotation, the first notch 2 and the second notch 3 being formed by helical grooves.

Advantageously, the material of the second screw 5 is harder than the material of the first component 1. In addition, the first screw 4 and the second screw 5 can be configured to have different dimensions to prevent any confusion during reassembly.

The edge of the first notch 2 and/or of the second notch 3 may include a graduated scale visible in any position of the first screw 4 or respectively of the second screw 5.

The invention also relates to a timepiece mechanism 500 including at least one such position-setting and marking device 100.

According to a further aspect, the invention relates to a timepiece 1000, in particular a watch, comprising such a timepiece mechanism.

In brief, the invention makes it possible to mark an initial setting that can be relocated in successive reassemblies.

1. A device (100) for setting the position and marking the said position, capable of immobilising a first component (1) and a second component (10) of a timepiece mechanism (500) relative to one another, the said first component and the said second component (1, 10) being arranged so as to be assembled with one another with a single degree of freedom in rotation and/or translation, and so as to be immobilised with each another by the cooperation of a first screw (4) with a first tapping (12) of the second component (10) arranged opposite a first notch (12) of the first component (1), the position-setting and marking device (100) being characterised in that the first component and the second component (1, 10) are arranged to be immobilised with each other by the cooperation of a second screw (5) with a second tapping (13) of the second component (10) arranged opposite a second notch (3) of the first component (1), said first notch and second notch (2, 3) defining a setting range according to the single degree of freedom, and in that said first screw (4) is arranged, when subjected to a first tightening torque, to create friction allowing a setting of the relative positioning between the first component and the second component (1, 10) according to the single degree of freedom, and, when subjected to a second tightening torque greater than said first tightening torque, to immobilise said the first component and the said second component (1, 10) in position with each other, and further characterised in that the second screw (5) is a screw with a non-flat head capable of imprinting a mark on the edge of said second notch (3) when it is subjected to a third tightening torque, the imprint being representative of the imposed position of the first component and second component (1, 10) relative to each other.

2. The position-setting and marking device (100) according to claim 1, characterised in that the second tightening torque is greater than the third tightening torque.

3. The position-setting and marking device (100) according to claim 1, characterised in that the said first component (1) and the said second component (10) are arranged so as to be assembled with one another with a single degree of freedom in rotation about an axis of rotation, and in that the said first notch (2) and the said second notch (3) are oblong grooves that are concentric with respect to said axis of rotation.

4. The position-setting and marking device (100) according to claim 1, characterised in that the said first component (1) and the said second component (10) are arranged to be assembled with each other with a single degree of freedom in translation, and in that the said first notch (2) and the said second notch (3) are aligned or parallel straight grooves.

5. The position-setting and marking device (100) according to claim 1, characterised in that the material of the second screw (5) is harder than the material of the first component (1).

6. The position-setting and marking device (100) according to claim 1, characterised in that the second screw (5) includes a conical head.

7. The position-setting and marking device (100) according to claim 1, characterised in that the edge of the first notch (2) and/or of the second notch (3) includes a graduated marking scale visible in any position of the said first screw (4) or respectively of the said second screw (5).

8. The position-setting and marking device (100) according to claim 1, characterised in that the first screw (4) and the second screw (5) are of different dimensions.

9. A timepiece mechanism (500) including the position-setting and marking device (100) according to claim 1.

10. A timepiece (1000) including the timepiece mechanism (500) according to claim 9.
